(19) United States
(12) Patent Application Publication
(10) Pub. No.: US 2010/0282801 A1
(43) Pub. Date: Nov. 11, 2010

(54) Collapsible Motorcycle Luggage Rack

(76) Inventors: John Willard, Coeur d' Alene, ID (US); Allen W. Brunscher, Coeur d' Alene, ID (US)

Correspondence Address: JAMES, VERNON & WEEKS, P.A., 1626 Lincoln Way, COEUR D''ALENE, ID, 83814, US

(21) Appl. No.: 12/435,851

(22) Filed: May 5, 2009

(51) Int. Cl. B62J 7/00

(52) U.S. Cl. 224/413; 224/427; 224/432

(57) ABSTRACT

A collapsible luggage rack designed to easily secure to the existing backrest or “sissy bar” of a motorcycle. The luggage rack is designed to attach to the motorcycle using pre-existing holes that also secure the backrest to the motorcycle. A pair of adjustable mounting brackets allows the luggage rack to fit a wide variety of motorcycles. The luggage rack prominently features several panels that may be fixed in a number of desired positions by simply pressing a lever and rotating the panel to the desired position. Depending on the conformation of the panels, the luggage rack is thus adaptable to safely securing a wide variety of loads depending on the needs of the operator.

### BACKGROUND

The present invention relates to an improved luggage rack for use with a cycle vehicle such as a motorcycle. Unlike automobiles which have varying degrees of storage, motorcycles as a class are unified by a limited degree of storage. The prior art contains a variety of items that have sought to address this problem by increasing the storage capacity of the motorcycle. The most common of these items include: luggage racks, saddle bags, containers, and even trailers that may be towed behind the motorcycle.

Among the above listed items, the luggage rack remains one of the cheapest and most effective means of increasing the storage space on a motorcycle. The luggage racks known in the art are substantially flat in structure and require the rider to have some means of securing the load to the luggage rack. Typically, some type of cord is used to secure the load to the luggage rack. This is not only time consuming but impractical for a variety of items that do not lend themselves to being easily or safely secured to a traditional luggage rack. Some notable examples of items that the rider may have trouble securing include a helmet, a carton of milk, a loaf of bread, etc.

Accordingly, there is a need for a novel motorcycle luggage rack which retains the unobtrusive design of prior luggage racks when not in use, while increasing the efficacy and range of items that may be safely secured to the luggage rack. The present invention serves to remedy the shortcomings of the prior art.

### SUMMARY

The present invention is directed to a novel collapsible luggage rack that satisfies the need for more effective means of securing items to a motorcycle vehicle without compromising the overall visual aesthetic of the motorcycle. When the panels of the luggage rack are placed in the down position, the luggage rack is capable of securing larger items in a fashion similar to a traditional luggage rack. However, when the panels of the luggage rack are extended, a variety of items that were difficult to safely secure on a traditional luggage rack may be easily secured.

In a preferred embodiment, the luggage rack features a base that is designed for attachment to the existing backrest or “sissy bar” of the motorcycle by way of mounting brackets. The mounting brackets are adjustable to fit any standard backrest on the market by securing to the interior of the U-shaped backrest. Fasteners such as a nut and bolt are used to secure the mounting brackets to pre-existing apertures in the backrest that allow the backrest to secure to the plated member that in turn secures the backrest to the motorcycle. Typically, two bolts on each side will slide through the pre-existing lower set of apertures in the backrest. These bolts are then secured to the mounting brackets. Another set of fasteners will slide thru the upper set of apertures in the backrest whereupon they will secure to a keeper that attaches directly to a slotted section in the mounting bracket.

The angle of the luggage rack is adjustable in at least two manners. In one manner, the length of the keeper which attaches to the uppermost bolt on the sissy bar and thence to the mounting bracket may be varied. In another manner, the location whereby the keeper secures to the diamond shaped slotted section in the mounting bracket will further adjust the angle of the luggage rack.

The mounting brackets are further secured to the base of the luggage rack using the additional slotted sections located in the base of the luggage rack that run perpendicular to the length of the motorcycle and attach to the mounting brackets by way of a fastener such as a bolt and nut. In this fashion, the mounting brackets can be adjusted to fit the appropriate width of the backrest the rack is attached to depending on where in the slotted sections on the luggage rack the mounting brackets are secured. Additionally, the mounting brackets have slotted sections that run perpendicular to the slotted sections on the luggage rack, in this way the rack may be adjusted to move towards or away from the backrest the desired distance before it is secured.

Attached to the luggage rack by a hinged means are a series of panels which may be locked in a substantially vertical or horizontal position depending on the desire and storage needs of the rider.

In the preferred embodiment, there are three panels attached to the base of the luggage rack with the back rest acting as a fourth wall. This creates a “box” in which a variety of items may be quickly and safely secured. The panels are raised or lowered by pressing a bar that allows the panels to move to a number of preset positions by releasing the locking mechanism that is biased towards a position of engagement with the panel by means of a spring.

### BRIEF DESCRIPTION OF THE DRAWINGS

These and other features, aspects and advantages of the present invention will become better understood with regard to the following description, claims, and accompanying drawings where:

FIG. 1 shows a perspective view of the luggage rack mounted on a motorcycle.

FIG. 2 shows a side view of the luggage rack mounted on a motorcycle.

FIG. 3 shows a top view of the luggage rack with the panels extended.

FIG. 4 shows a bottom view of the luggage rack with the panels collapsed.

FIG. 5 shows a rear view of the luggage rack with the panels extended.

FIG. 6 shows a front view of the luggage rack with the panels extended.

FIG. 7 shows an enlarged view of a hinge mechanism connecting a panel to the base member.

FIG. 8 shows an exploded perspective of a mounting bracket attached to the “sissy bar” and frame of a motorcycle.

### DESCRIPTION

The present invention satisfies the need in the art for a luggage rack that is collapsible and easily attachable to most backrests or “sissy bars” on the market today.

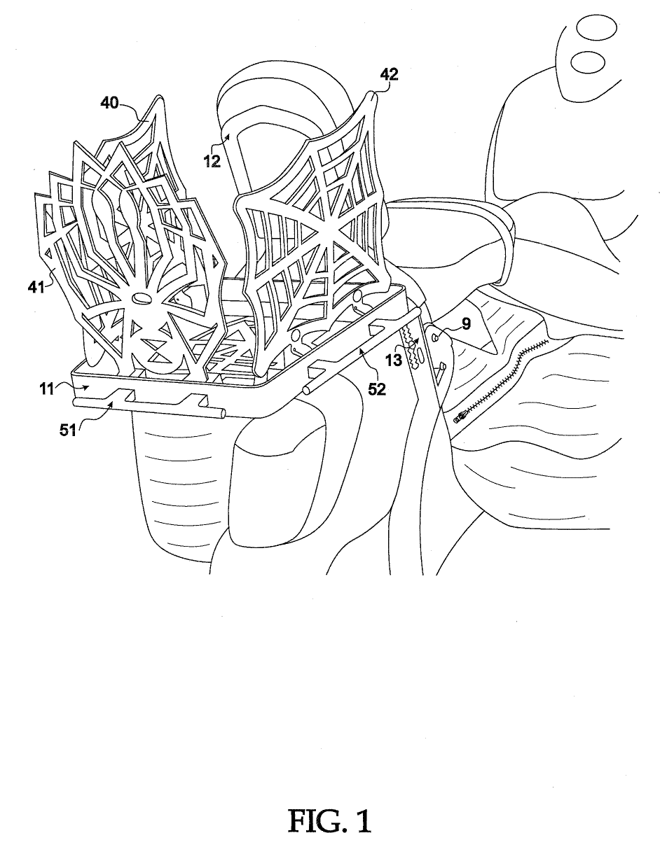

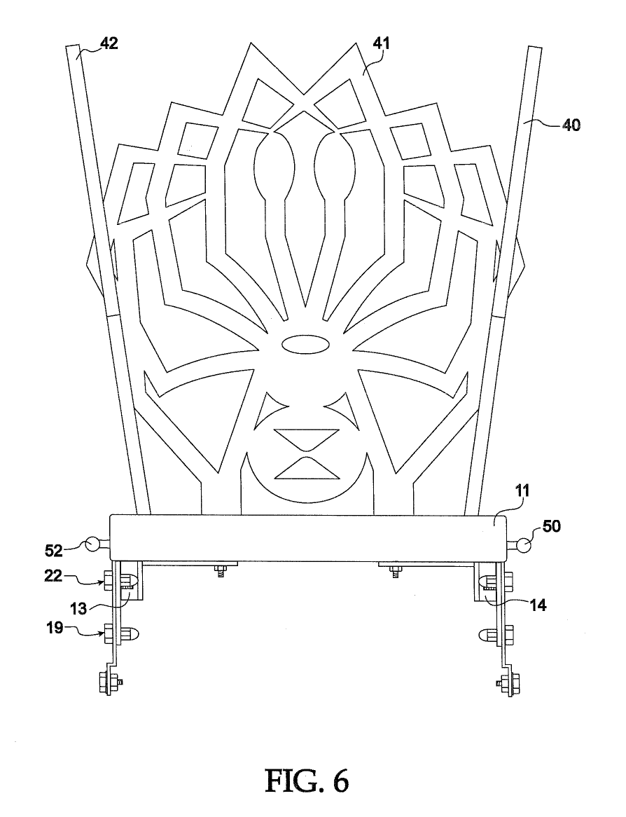

In a preferred embodiment of the luggage rack, shown in FIGS. 1-8 there is shown a base member 11 that is secured to the existing backrest or “sissy bar” 12 by way of a pair of adjustable mounting brackets 13 and 14. It will be appreciated to those in the art that each mounting bracket is a mirror image of the other and for that reason; only a single mounting bracket 13 will be described below.

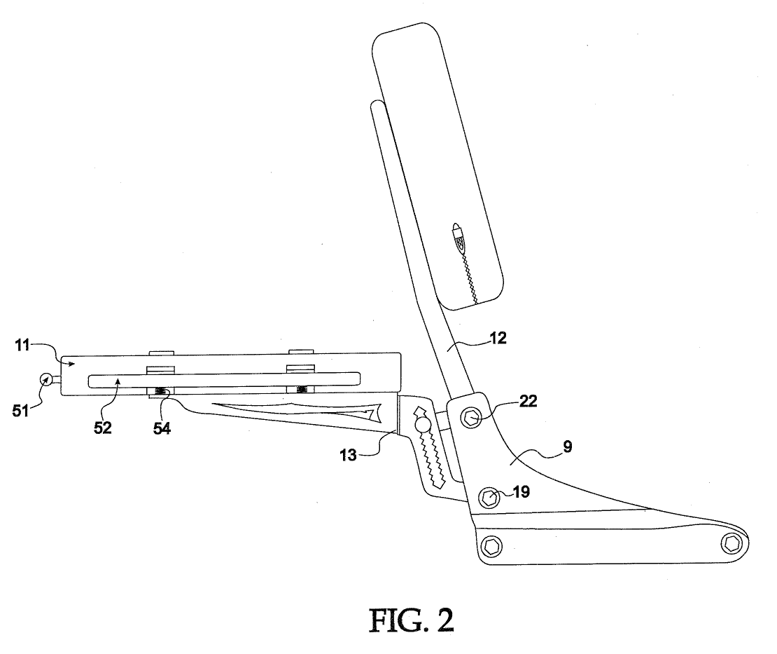

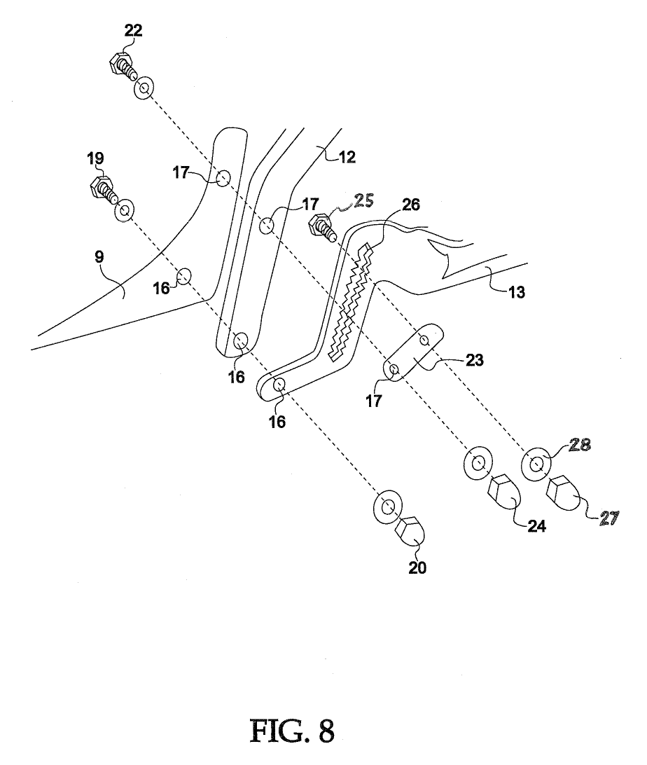

The mounting bracket 13 as seen in FIGS. 2 and 8 has a Z shape when viewed in profile and attaches to the existing backrest 12 by way of a fastener such as a bolt 19 that passes thru a lower set of apertures 16 located in the supporting frame of the plated member 9 and the backrest 12 and is then further secured with a nut 20. The bolt 19 used will typically range in size from 5/16″ down to 6 mm. A spacer may be used as necessary for smaller bolts. The mounting bracket 13 is further secured to the backrest 12 and plated member 9 by a second fastener such as a bolt 22 that passes thru an upper set of apertures 17 located directly above the previously described apertures 16. This bolt 22 will then pass thru a keeper 23 before being secured by a nut 24. The keeper 23 attaches to the mounting bracket 13 by means of a carriage bolt 25 that passes thru the keeper 23 and is secured into position in the diamond shaped slot 26 of the mounting bracket 13 with a nut 27 and washer 28. The carriage bolt 25 is chosen for this purpose as the square portion of the bolt securely mates with the desired area of attachment in the diamond shaped slot 26.

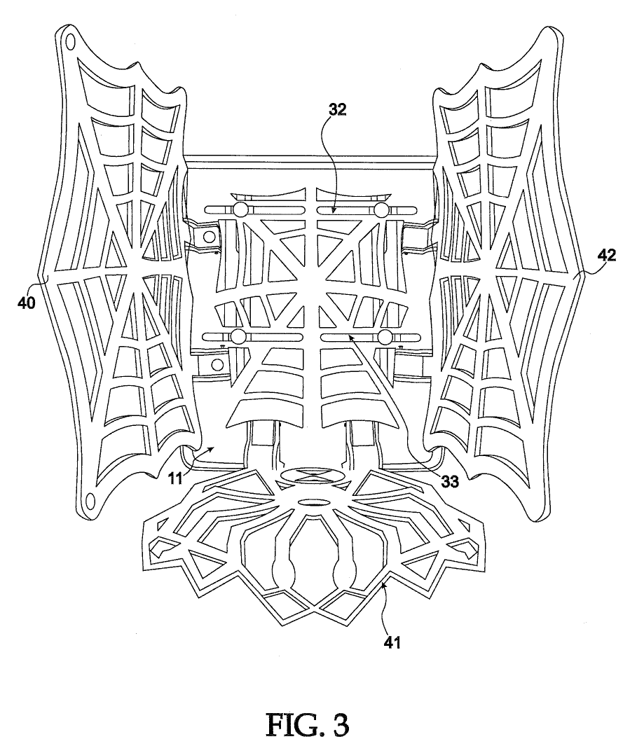

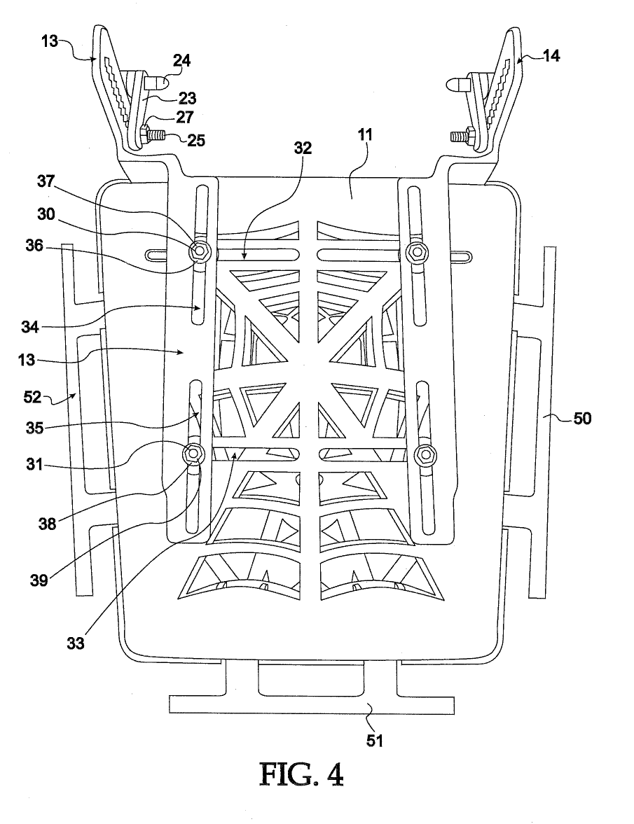

As shown in FIGS. 3 and 4, the mounting bracket 13 is then secured to the base member 11 by two carriage bolts 30 and 31 that pass thru slotted sections 32 and 33 in the base member 11 and slotted sections 34 and 35 in the mounting bracket 13 whereupon bolt 30 is secured by a washer 36 and nut 37 and bolt 31 is secured by a washer 38 and nut 39.

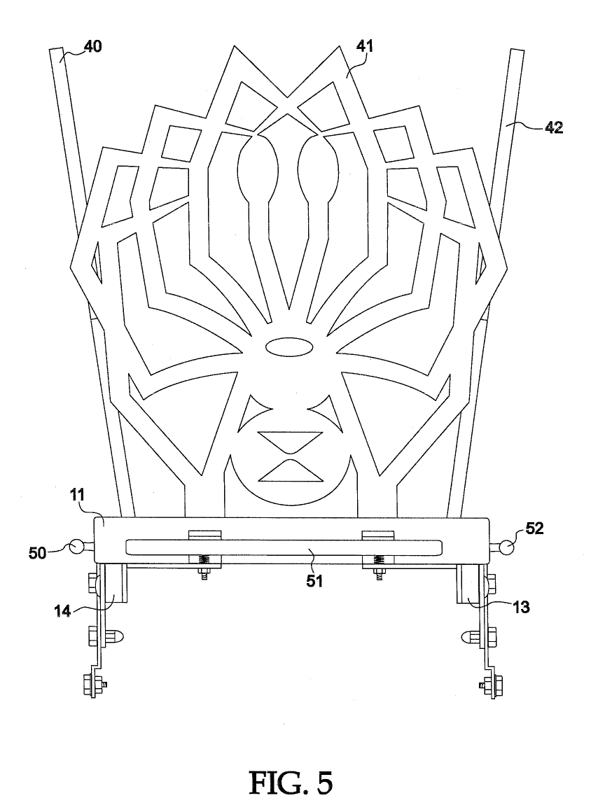

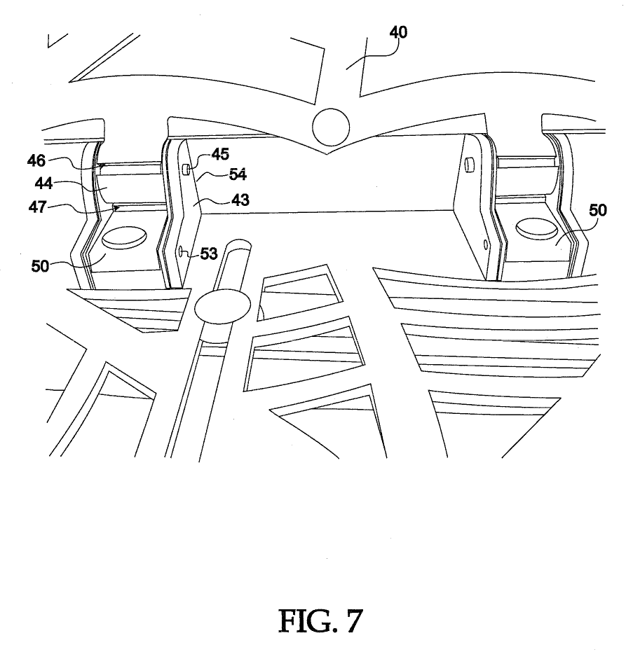

The collapsible panels 40, 41, and 42 as shown in FIGS. 1, 3, 5, and 6 are attached to the base member 11 via a mounting assembly 43 that has been welded to the base member 11. As all panels use a similar means of attachment, only one panel 40 will be discussed in detail as shown in FIG. 7. Regarding the panel 40 at issue, a round ¾″ by ¾″ rod 43 is welded to the panel 40 and secured in the mounting assembly 43 by means of a pin 45 that passes thru the rod 44 and the mounting assembly 43. The rod 44 has slots cut at predetermined levels (e.g. slot 46) which correspond to the desired position of the panel 40. The handle section 50 is secured to the mounting assembly 43 by means of a pin 53 that passes thru the handle 50 and mounting assembly 43. The handle 50 contains a triangle shaped section 47 that extends upward mating with the desired slot in rod 44 to secure the panel 40. The handle 50 is biased towards a position of engagement with the rod 44 by way of a spring 54 which is located beneath the handle 50 and shown in FIGS. 2 and 5.

In operation, installing the rack is quite simple. Each mounting bracket mirrors the other and for that reason only half of the installation is described below. As most backrests incorporate a four point attachment by way of bolting the plated member 9 to the backrest 12, the base member 11 is able to secure to the backrest 12 and plated member 9 using the pre-existing apertures 16 and 17 by which the mounting bracket 13 secures using the appropriate sized fasteners, such as a bolt and nut. Once the base member 11 has been secured to the backrest 12 by way of the mounting bracket 13, the angle of the base member 11 may be changed by varying the length of the keeper 23 and/or by varying the location by which the keeper 23 secures to the slotted diamond shaped section 26 of the mounting bracket 13.

As the width of the backrest 12 will vary depending on the motorcycle, the mounting bracket 13 is able to move inside the slotted sections 32 and 33 of the base member 11 prior to securing to the carriage bolts 30 and 31 as seen in FIG. 4. In this fashion, the mounting bracket 13 is able to adjust to the desired width of backrest 12 to which the base member 11 attaches. Furthermore, the distance from the backrest 12 to the base member 11 may be varied by changing the location in the slotted sections 34 and 35 of the mounting bracket 13 to which the base member 11 secures to the mounting bracket 13.

As each panel is identical in function, for the sake of example, only one panel 40 will be described below as seen in FIG. 7. The collapsible panel 40 may be moved into the desired position by pressing down on the handle 50 which disengages the handle 50 from the panel 40 and allows the panel 40 to pivot on the pin 45 to the desired position, whereupon the handle 50 is disengaged and the panel 40 is locked into one of a number of pre-determined positions.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the collapsible luggage rack. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Also, any element in a claim that does not specifically state “means for” performing a function, should not be interpreted as a “means” or “step” clause as specified in 35 U.S.C. §112.

What is claimed is:

1. A luggage rack for attachment to a motorcycle having a sissy bar, said luggage rack comprising:
(a) a pair of mounting brackets secured to a sissy bar using fasteners and connected to;
(b) a substantially rigid base panel using fasteners whereby said base panel is also coupled to;
(c) substantially rigid panels pivotally mounted and coupled to the upper side of said base panel, whereby the pivotally mounted panels may be fixed in a variety of desired positions.

2. The luggage rack of claim 1 whereby said pivotally mounted panels may be rotated to a variety of desired positions by pressing on a handle that is coupled to the pivotally mounted panel.

3. The luggage rack of claim 2 wherein said handle is biased towards a position of engagement with said pivotally mounted panel.

4. The luggage rack of claim 2 whereby each pivotally mounted panel contains at least one recessed channel that mates with the handle and secures said pivotally mounted panel in the desired position.

5. The luggage rack of claim 4 whereby said handle is biased towards a position of engagement with the pivotally mounted panel using a spring positioned beneath said handle.

6. The luggage rack of claim 4 wherein said mounting brackets are adjustable by varying the location where fasteners secure in said mounting brackets.

7. The luggage rack of claim 6 wherein the pivotally mounted panels are made of chrome plated steel.

8. The luggage rack of claim 7 wherein the pivotally mounted panels carry indicia.

9. A luggage rack for attachment to a wheeled vehicle, said luggage rack comprising:
(a) a pair of adjustable mounting brackets secured to the wheeled vehicle using fasteners and then connected to;
(b) a substantially rigid base panel using fasteners whereby said base panel is also coupled to;
(c) substantially rigid panels pivotally mounted and coupled to the upper side of said base panel whereby the pivotally mounted panels may be fixed in a variety of desired positions by;
(d) pressing on a handle that is coupled to the pivotally mounted panel.

10. The luggage rack of claim 9 wherein said handle is biased towards a position of engagement with said pivotally mounted panel.

11. The luggage rack of claim 10 whereby each pivotally mounted panel contains at least one recessed channel that mates with said handle and secures said pivotally mounted panel in the desired position.

12. The luggage rack of claim 11 whereby said handle is biased towards a position of engagement with the pivotally mounted panel using a spring positioned beneath said handle.

13. The luggage rack of claim 12 wherein the pivotally mounted panels are made of chrome plated steel.

14. The luggage rack of claim 13 wherein the pivotally mounted panels carry indicia.

15. A collapsible luggage rack for attachment to a motorcycle having a sissy bar, said luggage rack comprising:
(a) a pair of mounting brackets secured to said sissy bar using fasteners passing thru pre-existing apertures in said sissy bar that fix the mounting bracket to said sissy bar when secured, said mounting brackets are then connected to;
(b) a substantially rigid base panel using fasteners passing thru said base panel that fix said mounting brackets to said base panel when secured, whereby said base panel is also coupled to;
(c) substantially rigid panels that are pivotally mounted on the upper side of said base panel whereby the pivotally mounted panels may be fixed in a variety of desired positions by;
(d) pressing on a handle coupled to the pivotally mounted panel.

16. The luggage rack of claim 15 wherein said handle is biased towards a position of engagement with said pivotally mounted panel.

17. The luggage rack of claim 16 whereby each pivotally mounted panel contains at least one recessed channel that mates with the handle and secures said panel in the desired position.

18. The luggage rack of claim 17 whereby said handle is biased towards a position of engagement with the pivotally mounted panel using a spring positioned beneath said handle.

19. The luggage rack of claim 18 wherein the pivotally mounted panels are made of chrome plated steel.

20. The luggage rack of claim 19 wherein the pivotally mounted panels carry indicia.
